(19) United States
(12) Patent Application Publication
(10) Pub. No.: US 2026/0022639 A1
(43) Pub. Date: Jan. 22, 2026

(54) TURBINE BLADE COOLING FEATURES

(71) Applicant: Solar Turbines Incorporated, San Diego, CA (US)

(72) Inventors: Mostafa SOLIMAN, Farmington, CT (US); Aaron J. DICK, Woodstock, GA (US); David MEHAFFEY, San Diego, CA (US)

(73) Assignee: Solar Turbines Incorporated, San Diego, CA (US)

(21) Appl. No.: 18/666,001

(22) Filed: May 16, 2024

(51) Int. Cl. F01D 5/18; F01D 25/12

(52) U.S. Cl. CPC F01D 5/18; F01D 25/12; F05D 2260/20

(57) ABSTRACT

In a gas turbine engine, turbine blades are subjected to extremely high gas temperatures and mechanical stresses. Disclosed embodiments utilize one or more cooling and/or stress-reduction features. For example, flared and/or shaped cooling apertures may be provided through a platform, adjacent to a leading edge of a fillet of the airfoil of the turbine blade, and/or through the leading edge of the fillet. As another example, an aperture may provide coolant from an under-platform cavity to a trailing edge of the fillet. As another example, a tip flag may be provided in the interior of the airfoil, with trip strips to turbulate the flow of coolant through the tip flag and a reduced spar height to reduce stress. As another example, the aft axial end of a pin seal slot may axially extend beyond the fillet, in the aft direction, to reduce stiffness and produce beneficial transient behavior.

### TECHNICAL FIELD

The embodiments described herein are generally directed to a turbine blade, and, more particularly, to features for cooling a turbine blade.

### BACKGROUND

In a gas turbine engine, the turbine blades are subjected to extremely high gas temperatures and mechanical stresses. To reduce resultant metal temperatures and mechanical stresses to levels that satisfy service-life requirements, each turbine blade may comprise one or more internal cooling passages that circulate cooling air through the airfoil. The cooling air may flow from a cooling-air source that is radially inside a ring formed by the platforms of the turbine blades. The internal cooling passages in each turbine blade may extend through the platform to connect cooling passages within the airfoil to the cooling-air source.

It remains a challenge to efficiently supply coolant to the stages and regions of turbine blades that are subject to the highest temperatures and mechanical stresses, while remaining within the required design constraints. Not surprisingly, the need for effective cooling means increases as the size and power generation of the gas turbine engine increases.

There are a number of conventional solutions for supplying coolant through turbine blades. For example, U.S. Pat. No. 7,186,082 B2, issued on Mar. 6, 2007, U.S. Pat. No. 10,247,009 B2, issued on Apr. 2, 2019, and U.S. Pat. No. 7,217,096 B2, issued on May 15, 2007, each describes internal cooling passages for cooling various regions of a turbine blade. However, the passages in these references are unable to sufficiently cool all of the regions of the turbine blade that are subjected to high temperatures and mechanical stresses, especially in larger gas turbine engines.

The present disclosure is directed toward overcoming one or more of the problems discovered by the inventors.

### SUMMARY

In an embodiment, a turbine blade comprises: a platform; an airfoil extending radially outward from the platform, wherein the airfoil includes a fillet at an interface between the airfoil and the platform; an internal cooling channel that extends radially through the platform and into the airfoil, wherein the platform comprises a plurality of first apertures, wherein each of the plurality of first apertures respectively extends from the internal cooling channel to a first outlet that flares outward through an exterior surface of the platform at a position that is radially inward from a leading edge of the fillet, and wherein each first outlet is shaped to match an outer profile of the platform.

In an embodiment, a turbine blade comprises: a platform; an airfoil extending radially outward from the platform, wherein the airfoil includes a fillet at an interface between the airfoil and the platform; an internal cooling channel that extends radially through the platform and into the airfoil, wherein the platform comprises a plurality of first apertures, wherein each of the plurality of first apertures respectively extends from the internal cooling channel to a first outlet that flares outward through an exterior surface of the platform at a position that is radially inward from a leading edge of the fillet, and wherein each first outlet is shaped to match an outer profile of the exterior surface of the platform, wherein the fillet comprises a plurality of second apertures, wherein each of the plurality of second apertures respectively extends from the internal cooling channel to a second outlet that flares outward through the leading edge of the fillet, and wherein each second outlet is shaped to match an outer profile of the leading edge of the fillet, and wherein the turbine blade further comprises at least one third aperture that extends from an inlet through a radially inward facing surface of the platform, through an interior of the platform, to a third outlet through a trailing edge of the fillet.

In an embodiment, a turbine blade comprises: a platform; and an airfoil extending radially outward from the platform, wherein the airfoil includes a radial channel that is oriented radially within an interior of the airfoil, an axial channel that is oriented axially within the interior of the airfoil, wherein the axial channel comprises one or more outlets through a trailing edge on a pressure side of an exterior surface of the airfoil, a transitional channel that fluidly connects a radially outward end of the radial channel to a forward end of the axial channel, and a plurality of apertures, wherein each of the plurality of apertures respectively extends from the axial channel to an outlet through a radially outward end of the pressure side of the exterior surface of the airfoil.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a schematic diagram of a gas turbine engine, according to an embodiment;

FIG. 2 is a partially assembled turbine rotor assembly, according to an embodiment;

FIG. 3 is a side view of a turbine blade, according to an embodiment;

FIG. 4 is a perspective view of a portion of the turbine blade of FIG. 3 with a portion of the turbine blade shown as transparent, according to an embodiment;

FIG. 5 is a perspective view of a portion of the turbine blade of FIG. 3 with a portion of the turbine blade shown as transparent, according to an embodiment;

FIG. 6 is a perspective cross-sectioned view of a portion of the turbine blade of FIG. 3, according to an embodiment;

FIG. 7 is a cross-sectional view of a portion of the turbine blade of FIG. 3, according to an embodiment;

FIG. 8 is a perspective view of a pressure side of a radially outward end of an airfoil of the turbine blade of FIG. 3 with a portion of the airfoil shown as transparent, according to an embodiment;

FIG. 9 is a perspective view of a suction side of a radially outward end of an airfoil of the turbine blade of FIG. 3, according to an embodiment; and

FIG. 10 is a perspective view of a portion of a turbine blade of FIG. 3, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details.

In some instances, well-known structures and components are shown in simplified form for brevity of description. For clarity and ease of explanation, some surfaces and details may be omitted in the present description and figures. It should also be understood that the various components illustrated herein are not necessarily drawn to scale. In other words, the features disclosed in various embodiments may be implemented using different relative dimensions within and between components than those illustrated in the drawings.

References herein to “upstream” and “downstream” or “forward” and “aft” are relative to the flow direction of the primary gas (e.g., air or fuel) being discussed, unless specified otherwise. It should be understood that “upstream,” “forward,” and “leading” refer to a position that is closer to the source of the primary gas or a direction towards the source of the primary gas, and “downstream,” “aft,” and “trailing” refer to a position that is farther from the source of the primary gas or a direction that is away from the source of the primary gas. Thus, a trailing edge or end of a component (e.g., a turbine blade) is downstream from a leading edge or end of the same component. Also, it should be understood that, as used herein, the terms “side,” “top,” “bottom,” “front,” “rear,” “above,” “below,” “under,” and the like are used for convenience of understanding to convey the relative positions of various components with respect to each other, and do not imply any specific orientation of those components in absolute terms (e.g., with respect to the external environment or the ground).

As used herein, a reference numeral with an appended letter will be used to refer to a specific component, whereas the same reference numeral without any appended letter will be used to refer collectively to a plurality of the component or to refer to a generic or arbitrary instance of the component. In addition, the terms “respective” and “respectively” signify an association between members of a group of first components and members of a group of second components. For example, the phrase “each component A connected to a respective component B” would signify A1 connected to B1, A2 connected to B2, . . . and AN connected to BN.

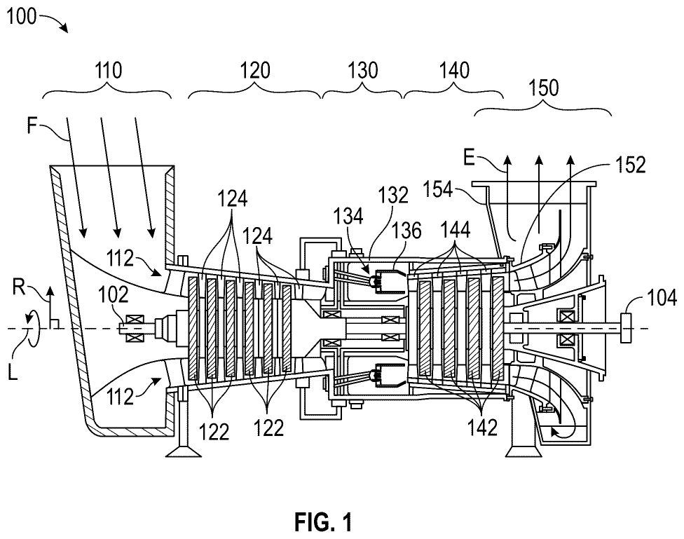

FIG. 1 is a schematic diagram of a gas turbine engine 100, according to an embodiment. Gas turbine engine 100 comprises a shaft 102 with a central longitudinal axis L. A number of other components of gas turbine engine 100 are concentric with longitudinal axis L and may be annular around longitudinal axis L. A radial axis may refer to any axis or direction that radiates outward from longitudinal axis L at a substantially orthogonal angle to longitudinal axis L, such as radial axis R in FIG. 1. Thus, the term “radially outward” should be understood to mean farther from or away from longitudinal axis L, whereas the term “radially inward” should be understood to mean closer to or towards longitudinal axis L. As used herein, the term “radial” will refer to any axis or direction that is substantially or mostly perpendicular to longitudinal axis L, and should be understood to include an axis or direction that is skewed by a relatively small angle (e.g., +/−20 degrees) from perfectly perpendicular to longitudinal axis L. As used herein, the term “axial” will refer to any axis or direction that is substantially or mostly parallel to longitudinal axis L, and should be understood to include an axis or direction that is skewed by a relatively small angle (e.g., +/−20 degrees) from perfectly parallel to longitudinal axis L.

In an embodiment, gas turbine engine 100 comprises, from an upstream end to a downstream end, an inlet 110, a compressor 120, a combustor 130, a turbine 140, and an exhaust outlet 150. In addition, the downstream end of gas turbine engine 100 may comprise a power output coupling 104. One or more, including potentially all, of these components of gas turbine engine 100 may be made from stainless steel and/or durable, high-temperature materials known as “superalloys.” A superalloy is an alloy that exhibits excellent mechanical strength and creep resistance at high temperatures, good surface stability, and corrosion and oxidation resistance. Examples of superalloys include, without limitation, Hastelloy, Inconel, Waspaloy, Rene alloys, Haynes alloys, Incoloy, MP98T, TMS alloys, and CMSX single crystal alloys.

Inlet 110 may funnel a working fluid F into an annular flow path 112 around longitudinal axis L. Working fluid F flows through inlet 110 into compressor 120. While working fluid F is illustrated as flowing into inlet 110 from a particular direction and at an angle that is substantially orthogonal to longitudinal axis L, it should be understood that inlet 110 may be configured to receive working fluid F from any direction and at any angle that is appropriate for the particular application of gas turbine engine 100. While working fluid F will primarily be described herein as air, it should be understood that working fluid F could comprise other fluids, including other gases.

Compressor 120 may comprise a series of compressor rotor assemblies 122 and compressor stator assemblies 124. Each compressor rotor assembly 122 may comprise a rotor disk that is circumferentially populated with a plurality of compressor blades. The compressor blades in a rotor disk are separated, along the axial axis, from the compressor blades in an adjacent disk by a compressor stator assembly 124. Compressor 120 compresses working fluid F through a series of stages corresponding to each compressor rotor assembly 122. The compressed working fluid F then flows from compressor 120 into combustor 130.

Combustor 130 may comprise a combustor case 132 that houses one or more and generally a plurality of fuel injectors 134. In an embodiment with a plurality of fuel injectors 134, fuel injectors 134 may be arranged annularly around longitudinal axis L within combustor case 132 at equidistant intervals. Combustor case 132 diffuses working fluid F, and fuel injector(s) 134 inject fuel into working fluid F. This injected fuel is ignited to produce a combustion reaction in one or more combustion chambers 136. The product of the combustion reaction drives turbine 140.

Turbine 140 may comprise one or more turbine rotor assemblies 142 and turbine stator assemblies 144 (e.g., nozzles). Each turbine rotor assembly 142 may correspond to one of a plurality or series of stages, and may comprise a rotor disk that is circumferentially populated with a plurality of turbine blades arranged annularly around longitudinal axis L. Turbine 140 extracts energy from the combusting fuel-gas mixture as the mixture passes through each stage. The energy extracted by turbine 140 may be transferred via power output coupling 104 (e.g., to an external system), as well as to compressor 120 via shaft 102.

The exhaust E from turbine 140 may flow into exhaust outlet 150. Exhaust outlet 150 may comprise an exhaust diffuser 152, which diffuses exhaust E, and an exhaust collector 154 which collects, redirects, and outputs exhaust E. It should be understood that exhaust E, output by exhaust collector 154, may be further processed, for example, to reduce harmful emissions, recover heat, and/or the like. In addition, while exhaust E is illustrated as flowing out of exhaust outlet 150 in a specific direction and at an angle that is substantially orthogonal to longitudinal axis L, it should be understood that exhaust outlet 150 may be configured to output exhaust E towards any direction and at any angle that is appropriate for the particular application of gas turbine engine 100.

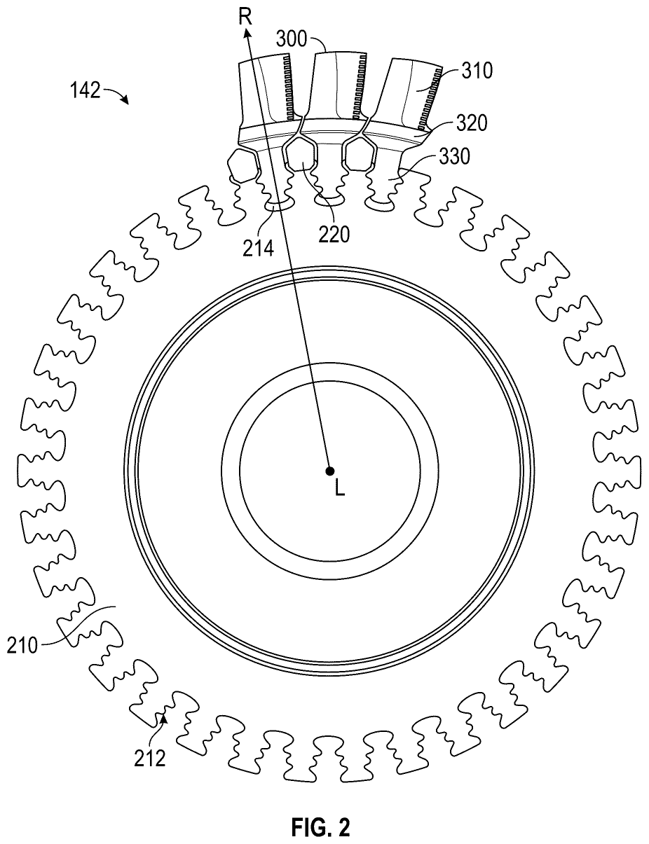

FIG. 2 is a partially assembled turbine rotor assembly 142 of a gas turbine engine, such as gas turbine engine 100, according to an embodiment. Each turbine rotor assembly 142 may comprise a rotor disk 210 that is annular around and concentric with longitudinal axis L. Rotor disk 210 may comprise a plurality of axial attachment grooves 212 arranged at equidistant intervals around the circumference of rotor disk 210. While rotor disk 210 is illustrated with thirty-four attachment grooves 212, it should be understood that rotor disk 210 may comprise any number of attachment grooves 212, depending on applicable design factors.

Each attachment groove 212 is configured to receive a turbine blade 300 therein. Each turbine blade 300 may comprise an airfoil 310, platform 320, and root 330. The sides of root 330 of each turbine blade 300 are configured to mate with the sides of at least one attachment groove 212, such that root 330 may be slid axially into a respective attachment groove. The cross-sectional profiles of attachment groove 212 and root 330 may have a “fir tree,” “bulb,” “dove tail,” or other shape to prevent radial movement of root 330 relative to attachment groove 212. Thus, the engagement of root 330 with attachment groove 212 radially fixes turbine blade 300 within attachment groove 212. It should be understood that other components, when assembled into gas turbine engine 100, may act as retaining features to prevent axial movement of turbine blades 300.

When fully assembled, each attachment groove 212 in rotor disk 210 may hold a respective turbine blade 300. Thus, turbine rotor assembly 142 may comprise a plurality of turbine blades 300 arranged annularly around longitudinal axis L, with the platform 320 of each turbine blade 300 abutting the platform 320 of adjacent turbine blades 300 on both long sides, and each airfoil 310 extending from platform 320 along a radial axis R. Turbine rotor assembly 142, comprising a plurality of turbine blades 300, may be positioned in any one or more stages of turbine 140. In an embodiment, turbine blades 300 are comprised in a turbine rotor assembly 142 in at least the first stage of turbine 140, which is generally exposed to the highest gas temperatures and mechanical stresses. However, it should be understood that turbine blades 300 may be comprised in any subset of turbine rotor assemblies 142, including potentially all of turbine rotor assemblies 142 in turbine 140.

Root 330 of each turbine blade 300 may radially penetrate only partially into attachment groove 212, such that a cavity 214 is formed within each attachment groove 212, between the radially innermost end of root 330 and the radially innermost end of attachment groove 212. An under-platform cavity may also be formed under (i.e., radially inward from) the platforms 320, between the roots 330 of each pair of adjacent turbine blades 300 and/or radially outward from rotor disk 210.

A damper 220 may be fixed in the under-platform cavity between each pair of adjacent turbine blades 300. Each damper 220 may be configured to constrain or seal coolant within the under-platform cavity, such that positive pressure is created in the under-platform cavity, to thereby suppress the ingress of hot gases from above (i.e., radially outward from) platforms 320. This sealing and positive pressure also enables under-platform cavity to retain coolant (e.g., air), which may be used to supply one or more cooling features within turbine blades 300. In an alternative embodiment in which adjacent platforms 320 are sufficiently flush with an outer circumference of rotor disk 210 or the under-platform cavity is sufficiently small, dampers 220 may be omitted.

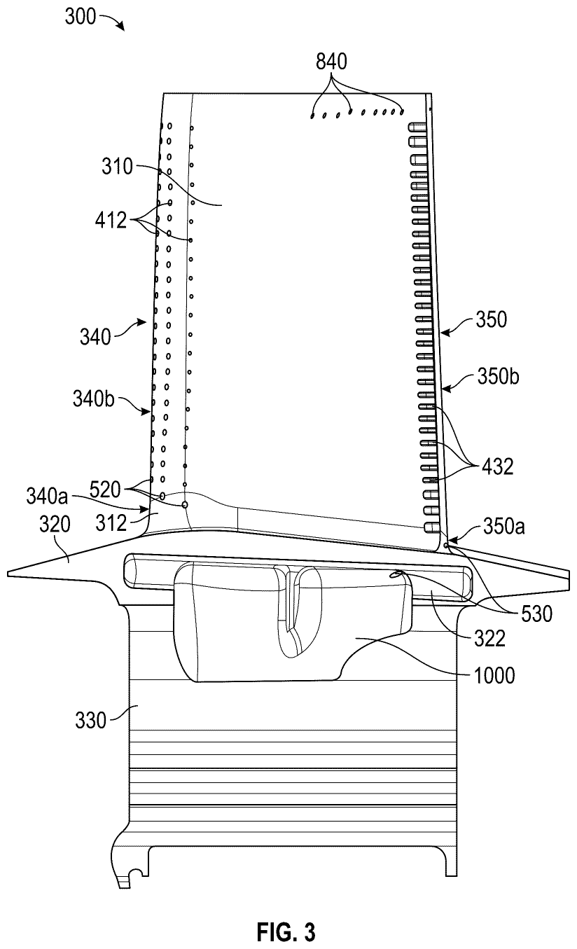

FIG. 3 is a side view of turbine blade 300, according to an embodiment. As mentioned above, turbine blade 300 comprises an airfoil 310, a platform 320, and a root 330. Turbine blade 300 has a leading edge 340 and a trailing edge 350. Airfoil 310 extends radially outward from platform 320 and comprises a fillet 312 at an interface between airfoil 310 and platform 320. Fillet 312 is a curved or otherwise contoured transition from the top surface of platform 320 to the side surfaces of airfoil 310. It is contemplated that fillet 312 is integral to the radially innermost end of airfoil 310, or alternatively integral to platform 320, as opposed to a discrete structure. However, in an alternative embodiment, fillet 312 could be a discrete structure from airfoil 310 and platform 320. The utilization of fillet 312 may improve the aerodynamics of turbine blade 300 by smoothing out sharp edges and corners, and/or reduce stress concentrations at the interface between the airfoil 310 and platform 320. Regions of leading edge 340 of turbine blade 300 include a leading edge 340a of fillet 312 and a leading edge 340b of the portion of airfoil 310 radially outward from fillet 312. Similarly, regions of trailing edge 350 of turbine blade 300 include a trailing edge 350a of fillet 312 and a trailing edge 350b of the portion of airfoil 310 radially outward from fillet 312. These regions 340a, 340b, 350a, and 350b are used herein to describe the placement and orientation of features within turbine blade 300.

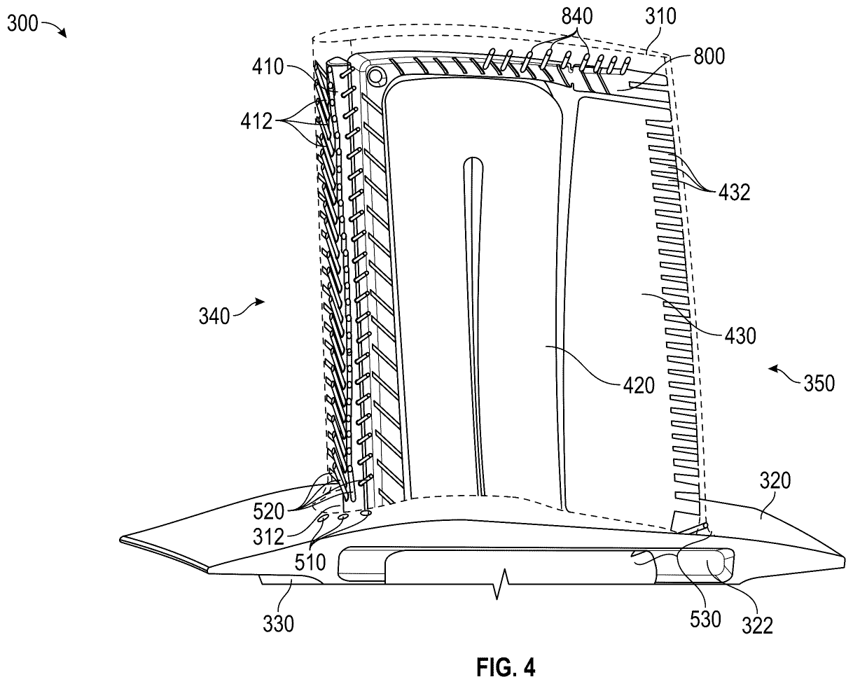

In FIG. 3, an external view of airfoil 310 shows a plurality of second apertures 520, an inlet and outlet of a third aperture 530, a plurality of apertures 412 of an internal cooling channel (shown in FIG. 4), a plurality of outlets 432 of a trailing-edge cooling passage (shown in FIG. 4), and a plurality of fourth apertures 840 are visible.

Still referring to FIG. 3, additional details of platform 320 are visible. For example, platform 320 may comprise a pin seal slot 322 along each of the long sides of platform 320, and a recess 1000 may be formed within a middle portion of pin seal slot 322 and extend radially from pin seal slot 322 to at least a radially outer region of root 330. Pin seal slot 322 and recess 1000 may be formed on both a pressure side and suction side of turbine blade 300.

FIG. 4 is a perspective view of a portion of turbine blade 300 of FIG. 3 with a portion of turbine blade 300 shown as transparent, according to an embodiment. In each transparent view illustrated herein, the transparent component will be illustrated with broken lines. In FIG. 4, airfoil 310 is transparent and is illustrated with broken lines, and as such, the internal structures within solid airfoil 310 are visible. It should be understood that within a transparent component, the internal components, illustrated in solid lines, may represent negative space within a solid piece of material. In general, these negative spaces represent fluid channels that are utilized to provide a flow path for coolant through the interior of turbine blade 300. For example, internal cooling channel 410, middle cooling passage 420, trailing-edge cooling passage 430, the plurality of first apertures 510, the plurality of second apertures 520, third aperture 530, and tip flag 800 represent negative spaces within turbine blade 300 that are utilized to provide a flow path for coolant through the interior of turbine blade 300.

In an embodiment, turbine blade 300 comprises an internal cooling channel 410, which may extend radially from root 330 through platform 320 and into airfoil 310. Internal cooling channel 410 may extend along or near the leading edge 340b of airfoil 310. An inlet (not shown) of internal cooling channel 410 in root 330 may be in fluid communication with a core cooling source (not shown) that is radially inside a ring formed by platforms 320 of a plurality of turbine blades 300 arranged annularly around longitudinal axis L in a turbine rotor assembly 142. For example, the core cooling source may be a cavity between the radially inward end of root 330 and rotor disk 210. Thus, coolant, such as air provided from compressor 120 to the core cooling source via a bleed circuit, may be supplied from the core cooling source through internal cooling channel 410. This coolant may flow along internal cooling channel 410 and be ejected out of one or more and generally a plurality of apertures 412 through leading edge 340b of airfoil 310, to thereby cool leading edge 340b of airfoil 310. In the illustrated embodiment, a plurality of rows of apertures 412, arranged in a radial column from near or adjacent to fillet 312 to the radially outward end (i.e., “tip”) of airfoil 310, are provided to supply coolant from internal cooling channel 410 to leading edge 340b of airfoil 310.

Turbine blade 300 may also comprise other internal cooling passages, in addition to or instead of internal cooling channel 410. For example, turbine blade 300 may comprise a middle cooling passage 420, aft of internal cooling channel 410, in or near the middle of airfoil 310 between leading edge 340b and trailing edge 350b of airfoil 310. Middle cooling passage 420 may comprise at least one serpentine passage that includes an inlet (e.g., in root 330) in fluid communication with the core cooling source, extends radially outward from the inlet through the interior of airfoil 310, curves or otherwise turns to extend axially near the tip of airfoil 310, and then curves or otherwise turns again to extend radially inward to an outlet or fluid connection to another internal cooling passage in root 330. Thus, middle cooling passage 420 supplies coolant through the middle portion of airfoil 310, to thereby cool the middle portion of airfoil 310.

In an embodiment, middle cooling passage 420 may comprise or consist of parallel dual passages, which may be oriented side-by-side and spaced apart, with a first one of the dual passages on a pressure side of airfoil 310 and a second one of the dual passages on a suction side of airfoil 310. The dual passages may be connected by one or more channels extending between the first and second passages, and/or may comprise other features (e.g., spars, ribs, trip strips, etc.) to aid in the cooling by middle cooling passage 420, the structural integrity of middle cooling passage 420, and/or the manufacture of turbine blade 300 with middle cooling passage 420.

As another example of an additional internal cooling passage, turbine blade 300 may comprise a trailing-edge cooling passage 430 that cools trailing edge 350b of airfoil 310. Trailing-edge cooling passage 430 may be aft of middle cooling passage 420. Trailing-edge cooling passage 430 may comprise at least one passage that includes an inlet in fluid communication with the core cooling source and extends radially outward from the inlet through the interior of airfoil 310, along or near trailing edge 350b of airfoil 310, to a plurality of outlets 432, which each extends axially through trailing edge 350b of airfoil 310. Thus, trailing-edge cooling passage 430 supplies coolant through trailing edge 350b of airfoil 310, to thereby cool trailing edge 350b of airfoil 310.

The internal cooling passages, including internal cooling channel 410, middle cooling passage 420, and/or trailing-edge cooling passage 430, may all be in fluid communication with the same core cooling source. Additionally or alternatively, two or more, including potentially all, of the internal cooling passages may be in fluid communication with each other, for example, via fluid connections within platform 320 or root 330.

In an embodiment, turbine blade 300 may comprise a tip flag 800 that cools the tip of airfoil 310. Tip flag 800 may be aft of internal cooling channel 410 and start forward of middle cooling passage 420. Tip flag 800 may comprise at least one passage that includes an inlet in fluid communication with the core cooling source, extends radially outward from the inlet through the interior of airfoil 310, and curves or otherwise turns to extend axially near a radially outward end of airfoil 310, at a position that is more radially outward than middle cooling passage 420, and through trailing edge 350b of airfoil 310, at a position that is aft of middle cooling passage 420 and radially outward from outlets 432 of trailing-edge cooling passage 430. Thus, tip flag 800 supplies coolant to the tip of airfoil 310, to thereby cool the tip of airfoil 310.

Still referring to FIG. 4, additional details of platform 320 are visible. In an embodiment, platform 320 comprises a plurality of first apertures 510. Each of the plurality of first apertures 510 extends from internal cooling channel 410 to a shaped outlet that flares outward through an exterior surface of platform 310 at a position that is radially inward from a leading edge 340a of fillet 312. Each outlet of each first aperture 510 may be shaped to match an outer profile of platform 320, which may be contoured. In an embodiment, the outlet of each of at least a subset, and potentially all, of the plurality of first apertures 510 is through the pressure side of platform 320, which is the side that is visible in FIG. 4. In the illustrated embodiment, platform 320 consists of three first apertures 510. However, it should be understood that there may be any number of first apertures 510, including one, two, three, four, five, or more first apertures 510. It is generally contemplated that the plurality of first apertures 510 would comprise at least three first apertures 510, but less than three first apertures 510 could be used depending on local temperature requirements.

In an embodiment, fillet 312 comprises a plurality of second apertures 520. Each of the plurality of second apertures 520 extends from internal cooling channel 410 to a shaped outlet that flares outward through the leading edge 340a of fillet 312 or at a position on leading edge 340b of airfoil 310 that is radially outward from and adjacent to fillet 312. Each outlet of each second aperture 520 may be shaped to match an outer profile of leading edge 340a of fillet 312, which is generally contoured. In the illustrated embodiment, fillet 312 consists of four second apertures 520. However, it should be understood that there may be any number of second apertures 520, including one, two, three, four, five, or more second apertures 520. In addition, although only a single row of second apertures 520 is illustrated, there may be a plurality of rows (e.g., two, three, or more rows) of second apertures 520 in fillet 312, with each row being positioned at a different radial position along leading edge 340a of fillet 312.

In an embodiment, turbine blade 300 may comprise at least one third aperture 530 that extends from an inlet, which is through a radially inward facing surface of platform 320, through an interior of platform 320, to an outlet through a trailing edge 350a of fillet 312. As illustrated, the inlet may be near a pin seal slot 322 of platform 320, and the outlet may be in the center of trailing edge 350a of fillet 312, with or without a bias towards the pressure side or suction side of fillet 312. Alternatively, the outlet of third aperture 530 could be on the pressure side or suction side of fillet 312, on platform 320 radially inward from and adjacent to trailing edge 350a of fillet 312, or on platform 320 at a distance from airfoil 310. Thus, coolant may be supplied from a cavity under (i.e., radially inward from) platform 320 (e.g., between adjacent turbine blades 300), through third aperture 530, to a pressure side of the trailing edge 350a of fillet 312, to thereby cool the pressure side of the trailing edge 350a of fillet 312. In the illustrated embodiment, turbine blade 300 consists of a single third aperture 530. However, it should be understood that there may be any number of third apertures 530, including one, two, three, four, five, or more third apertures 530.

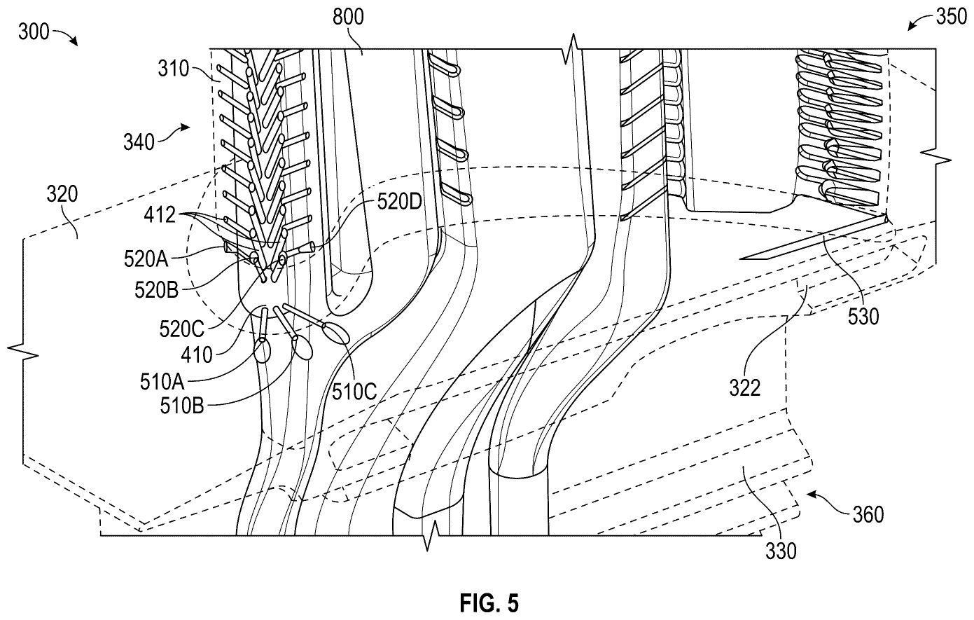

FIG. 5 is a perspective view of a portion of turbine blade 300 of FIG. 3 with a portion of turbine blade 300 shown as transparent, according to an embodiment. In FIG. 5, airfoil 310, platform 320, and root 330 are transparent and are illustrated with broken lines, and as such, the internal structures within airfoil 310, platform 320, and root 330 are visible. It should be understood that within a transparent component, the internal components, illustrated in solid lines, may represent negative space within a solid piece of material. In general, these negative spaces represent fluid channels that are utilized to provide a flow path for coolant through the interior of turbine blade 300. For example, all of the features shown in unbroken lines in FIG. 5 represent negative spaces. In this view, the flared and shaped outlets of three first apertures 510A, 510B, and 510C, and the flared and shaped outlets of four second apertures 520A, 520B, 520C, and 520D, are more clearly visible in the context of the interior features of turbine blade 300. In addition, third aperture 530 is shown to fluidly connect an under-platform cavity near (e.g., laterally interior to) pin seal slot 322 to trailing edge 350a of fillet 312. In the illustrated embodiment, the outlets of first apertures 510 and second apertures 520 are on pressure side 360 of turbine blade 300, so as to supply coolant to pressure side 360 of turbine blade 300. However, in an alternative embodiment, one or more outlets of first apertures 510 and second apertures 520 may be on suction side 370 of turbine blade 300, so as to supply coolant to suction side 370 of turbine blade 300. As illustrated, the outlet of third aperture 530 may be through the center of trailing edge 350a of fillet 312. In alternative embodiments, the outlet of third aperture 530 may be on pressure side 360 or suction side 370 of fillet 312.

As illustrated, tip flag 800 may be in fluid communication with internal cooling channel 410. In particular, tip flag 800 and internal cooling channel 410 may branch from a common inlet channel within the interior of airfoil 310, platform 320, and/or root 330 of turbine blade 300. Thus, internal cooling channel 410 and tip flag 800 may share an inlet (e.g., within root 330) that is in fluid communication with the core cooling source.

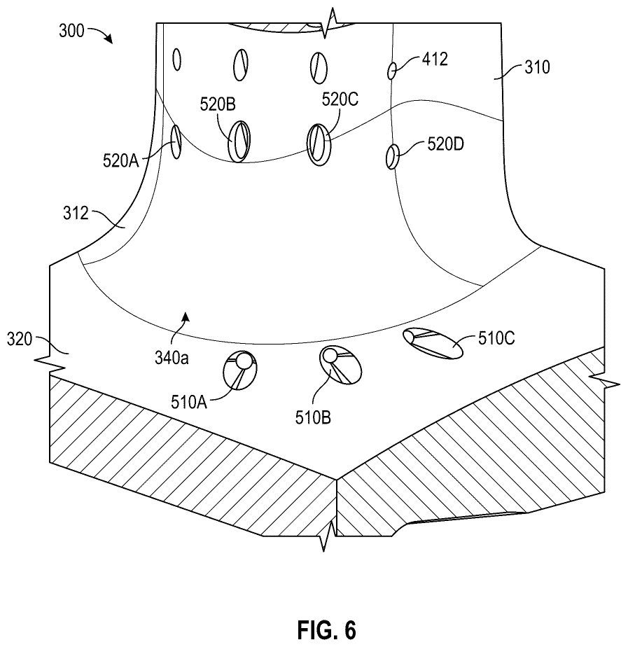

FIG. 6 is a cross-sectional view of a portion of turbine blade 300, according to an embodiment. In this view, the flared and shaped outlets of three first apertures 510A, 510B, and 510C, and the flared and shaped outlets of four second apertures 520A, 520B, 520C, and 520D, are more clearly visible in the context of the contoured surface of turbine blade 300, including fillet 312 and platform 320. Notably, unlike second aperture(s) 520, apertures 412, which are positioned radially outward from fillet 312 and second aperture(s) 520, may not be flared and/or may not be shaped to match the outer profile of leading edge 340b of airfoil 310. Alternatively, one or more apertures 412 may be flared and/or be shaped to match the outer profile of leading edge 340b of airfoil 310.

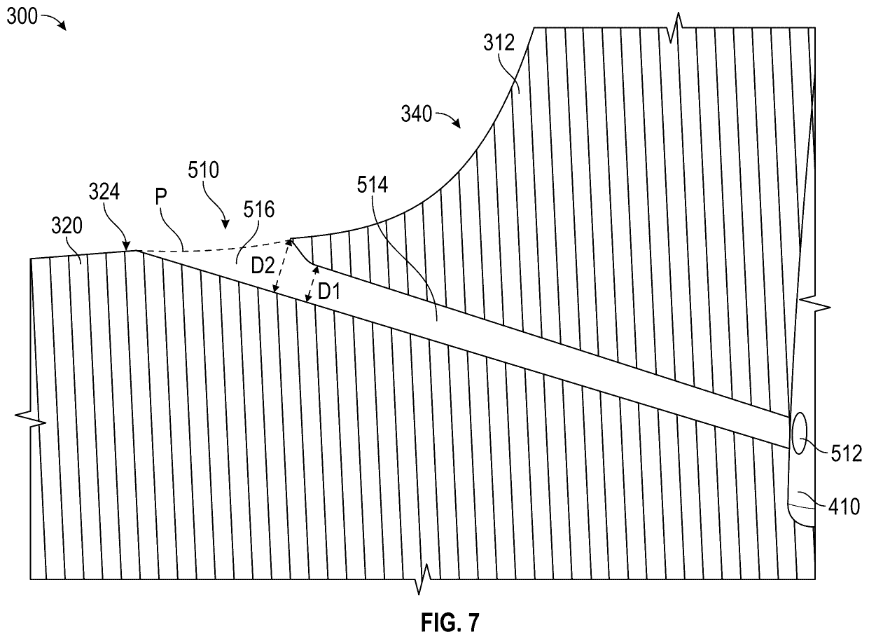

FIG. 7 is a cross-sectional view of a portion of turbine blade 300, according to an embodiment. In this view, one first aperture 510 is illustrated in cross-section. As illustrated, first aperture 510 may comprise an inlet 512 that is in fluid communication with internal cooling channel 410, an outlet 516 that extends through an outer surface 324 of platform 320 at a position that is radially inward from and adjacent to leading edge 340a of fillet 312, and an internal channel 514 that fluidly connects inlet 512 to outlet 516.

In an embodiment, outlet 516 flares outward, approaching outer surface 324. In particular, outlet 516 and internal channel 514 may both have a first diameter D1 at the interface between outlet 516 and internal channel 514. The diameter of outlet 516 increases, as the distance from internal channel 514 increases and the distance from outer surface 324 decreases, to a second diameter D2, which is greater than first diameter D1.

In an embodiment, outlet 516 is shaped to match an outer profile P of outer surface 324 of platform 320. In particular, the cross-sectional profile of outlet 516 matches the cross-sectional outer profile P of outer surface 324 at the position at which outlet 516 traverses outer surface 324. Thus, assuming cross-sectional outer profile P is curved, the cross-sectional profile of outlet 516 will also be curved in an identical or similar manner, so as to match cross-sectional outer profile P. As a result, the edges of outlet 516 through outer surface 324 may be generally circular or elliptical in shape, but without every point in the circle or ellipse lying within a single plane. However, it should be understood that the edges of outlet 516 could form any other shape, including a triangle, rectangle (e.g., square), pentagon, hexagon, or the like. Although, a circular or elliptical shape may facilitate manufacturing.

Although not illustrated, second apertures 520 may be configured in an identical or similar manner as first apertures 510. In particular, each second aperture 520 may comprise an inlet (e.g., identical or similar to inlet 512) that fluidly connects to a flared and/or shaped outlet (e.g., identical or similar to outlet 516) via an internal channel (e.g., similar or identical to internal channel 514). However, the outlet of each second aperture 520 is through an outer surface of leading edge 340a of fillet 312, instead of through outer surface 324 of platform 320.

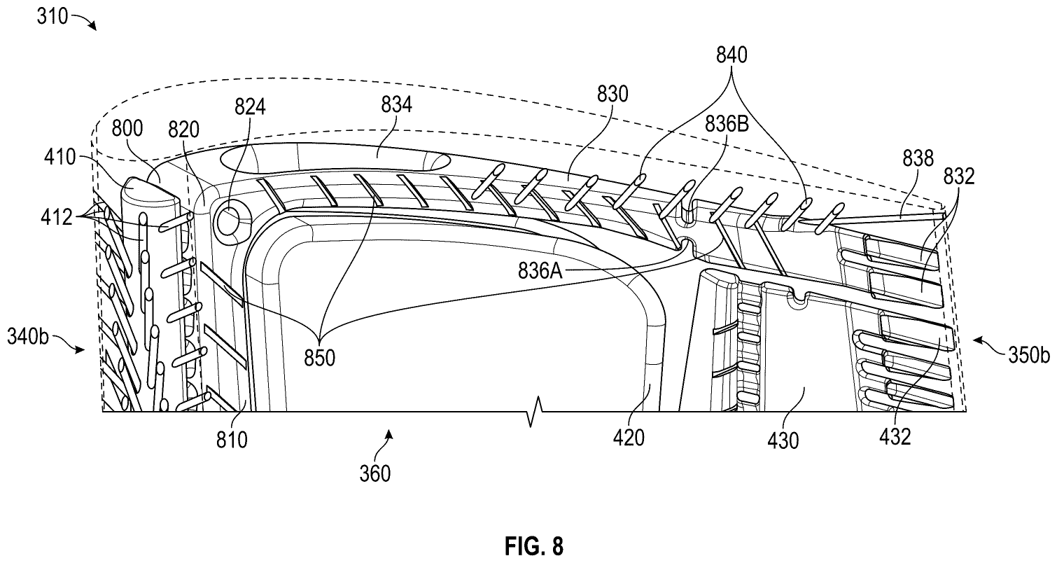

FIG. 8 is a perspective view of pressure side 360 of a radially outward end (i.e., tip) of airfoil 310 of turbine blade 300, with airfoil 310 shown as transparent, according to an embodiment. In FIG. 8, airfoil 310 is transparent and is illustrated with broken lines, and as such, the internal structures within airfoil 310 are visible. It should be understood that within a transparent component, the internal components, illustrated in solid lines, may represent negative space within a solid piece of material. In general, these negative spaces represent fluid channels that are utilized to provide a flow path for coolant through the interior of turbine blade 300. For example, all of the features shown in unbroken lines in FIG. 8 represent negative spaces.

In this embodiment, turbine blade 300 comprises a tip flag 800. As illustrated, tip flag 800 comprises a radial channel 810 that is oriented radially within an interior of airfoil 310, an axial channel 830 that is oriented axially within the interior of airfoil 310, and a curved channel 820 that fluidly connects a radially outward end of radial channel 810 to a forward end of axial channel 830. Radial channel 810 may be oriented parallel to internal cooling channel 410, and positioned aft of internal cooling channel 410 and forward of middle cooling passage 420 within the interior of airfoil 310. A radially inner end of radial channel 810 may be in fluid communication with the core cooling source, and/or, as mentioned elsewhere herein, may branch from the same inlet channel as internal cooling channel 410. Thus, tip flag 800 supplies coolant to the tip of airfoil 310, to thereby cool the tip of airfoil 310.

In an embodiment, axial channel 830 includes one or more outlets 832 that each extends through trailing edge 350b at or near the tip of airfoil 310. In the illustrated embodiment, axial channel 830 consists of two outlets 832. However, it should be understood that axial channel 830 may comprise any number of outlets 832, including one, two, three, four, five, or more outlets 832. Each outlet 832 may extend axially through trailing edge 350b of airfoil 310, in an identical or similar manner as outlets 432 of trailing-edge cooling passage 430, but at a position that is radially outward from outlets 432. Thus, tip flag 800 supplies coolant through trailing edge 350b of airfoil 310, to thereby cool trailing edge 350b of the tip of airfoil 310.

In an embodiment, tip flag 800 may comprise one or more and preferably a plurality of fourth apertures 840. For example, in the illustrated embodiment, each of a plurality of fourth apertures 840 respectively extends from axial channel 830 to an outlet through the exterior surface on pressure side 360 of the tip of airfoil 310 near the radially outermost edge of airfoil 310. The positions of the plurality of fourth apertures 840 may start at or near the axial middle of airfoil 310 and be arranged at axial intervals towards trailing edge 350b of airfoil 310. However, other positioning arrangements are possible. The illustrated embodiment consists of nine fourth apertures 840 that are all in direct fluid communication with axial channel 830. However, it should be understood that tip flag 800 may comprise any number of fourth apertures 840, including one or any other number less than nine, nine, or more than nine fourth apertures 840, and that at least a subset of fourth apertures 840 may be in direct fluid communication with another portion of tip flag 800, such as radial channel 810 and/or curved channel 820. In addition, while all of fourth apertures 840 are illustrated as having outlets through pressure side 360 of the exterior surface of airfoil 310, in an alternative embodiment, one or more fourth apertures 840 may have outlets through suction side 370 of the exterior surface of airfoil 310, and/or through the radially outward facing surface of the tip of airfoil 310.

In an embodiment, tip flag 800 comprises at least one fifth aperture 838 that extends from axial channel 830 to an outlet through a trailing edge 350b of airfoil 310 at or near the radially outermost surface of airfoil 310. Thus, coolant may be supplied from axial channel 830, through fifth aperture 838, to trailing edge 350b at the tip of airfoil 310, to thereby cool trailing edge 350b of the tip of airfoil 310. In the illustrated embodiment, tip flag 800 consists of a single fifth aperture 838. However, it should be understood that there may be any number of fifth apertures 838, including one, two, three, four, five, or more fifth apertures 838.

In an embodiment, tip flag 800 may comprise one or more features designed to meter, regulate, turbulate, or otherwise affect the flow of coolant through tip flag 800. For example, in an embodiment, tip flag comprises a plurality of trip strips 850. One or more trip strips 850 may be provided on pressure side 360 and/or suction side 370 of each of radial channel 810, curved channel 820, and/or axial channel 830. In the illustrated embodiment, each of radial channel 810 and axial channel 830 comprises a plurality of trip strips 850 on both pressure side 360 and suction side 370 of the respective channel. Trip strips 850 may be spaced apart along the respective channel according to any suitable distance interval or intervals. The particular spacing may depend on the particular design goals. Each trip strip 850 may be oriented at an angle with respect to a perfectly perpendicular radial axis and perfectly parallel axial axis, and trip strips 850 may all be oriented in the same direction or two or more trip strips may be oriented in different directions. While trip strips 850 are illustrated in a particular arrangement, it should be understood that trip strips 850 may be alternatively implemented in any other suitable arrangement.

Tip flag 800 may comprise one or more other features that are designed to meter, regulate, turbulate, or otherwise affect the flow of coolant through tip flag 800, provide strength or stability to airfoil 310, and/or facilitate the manufacture of turbine blade 300. For example, curved channel 820 may comprise a pedestal or pin fin 824 extending laterally through curved channel 820 (e.g., as a cylinder) between pressure side 360 and suction side 370. Similarly, axial channel 830 may comprise a rib or spar 834 extending radially through axial channel 830. Both pin fin 824 and spar 834 may comprise fillets that provide a smooth, contoured transition from one surface to another generally perpendicular surface. As another example, one or more protrusions or ribs 836, illustrated as mirrored ribs 836A and 836B, may extend into tip flag 800, to regulate coolant flow and/or provide structural support. In the illustrated embodiment, ribs 836 extend radially into axial channel 830 at an axial position that is between the aft end of middle cooling passage 420 and the forward end of trailing-edge cooling passage 430. Fourth apertures 840 may be provided on both axial sides of ribs 836.

Notably, spar 834 divides axial channel 830, and therefore, the coolant flow, into two parallel channels. The size of the fillets on spar 834, the length of spar 834, the width of spar 834, the location of the forward end of spar 834, the location of the aft end of spar 834, the radial height of spar 834, the distance between spar 834 and the radially outermost end of airfoil 310, and/or other dimensions of spar 834 may be optimized to reduce stress. Notably, spar 834 is thermally connected to the radially outermost surface of airfoil 310, which is subject to high temperatures and stress, but is laterally surrounded by parallel coolant flows. Thus, for example, reducing the radial height of spar 834, such that spar 834 is closer to the radially outermost surface of airfoil 310, reduces the temperature gradient across spar 834 and allows spar 834 to remain at a higher temperature.

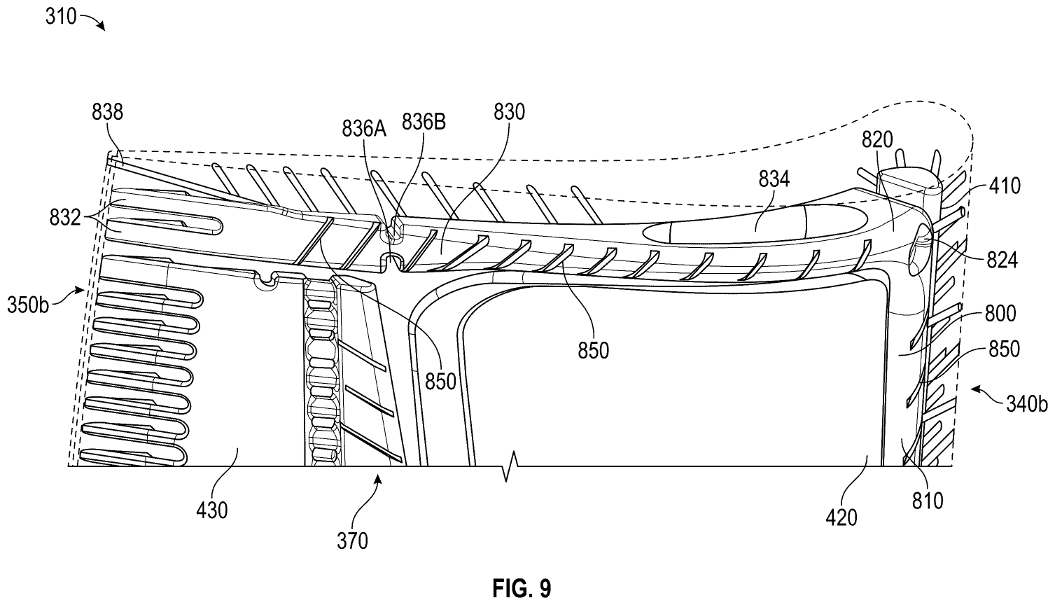

FIG. 9 is a perspective view of suction side 370 of a radially outward end (i.e., tip) of airfoil 310 of turbine blade 300, with airfoil 310 shown as transparent, according to an embodiment. In this view, it can be seen that trip strips 850 may be provided on suction side 370 of tip flag 800. In FIG. 9, airfoil 310 is transparent and is illustrated with broken lines, and as such, the internal structures within airfoil 310 are visible. It should be understood that within a transparent component, the internal components, illustrated in solid lines, may represent negative space within a solid piece of material. In general, these negative spaces represent fluid channels that are utilized to provide a flow path for coolant through the interior of turbine blade 300. For example, all of the features shown in unbroken lines in FIG. 9 represent negative spaces.

In an embodiment in which trip strips 850 are provided on both pressure side 360 and suction side 370 of tip flag 800, the trip strips may be staggered across tip flag 800, such that each trip strip 850 on pressure side 360 does not laterally align with any trip strip 850 on suction side 370. This means that the flow of coolant will hit a trip strip 850 on a first side, then a trip strip 850 on a second side, then hit a trip strip 850 on the first side, then hit a trip strip 850 on the second side, and so on and so forth. Alternatively, trip strips 850 on suction side 370 of tip flag 800 may be mirrored or otherwise aligned to trip strips 850 on pressure side 360 of tip flag 800, such that the flow of coolant simultaneously hits an aligned pair of trip strips 850 on pressure side 360 and suction side 370 of tip flag 800. In either case, there may be an equal number of trip strips 850 on suction side 370 as on pressure side 360 of tip flag 800, or a different number of trip strips 850 on suction side 370 of tip flag 800 than on pressure side 360 of tip flag 800. However, it is generally beneficial for trip strips 850 to be arranged in a uniform manner along tip flag 800. Notably, in the illustrated embodiment, there are no fourth apertures 840 on suction side 370 of airfoil 310.

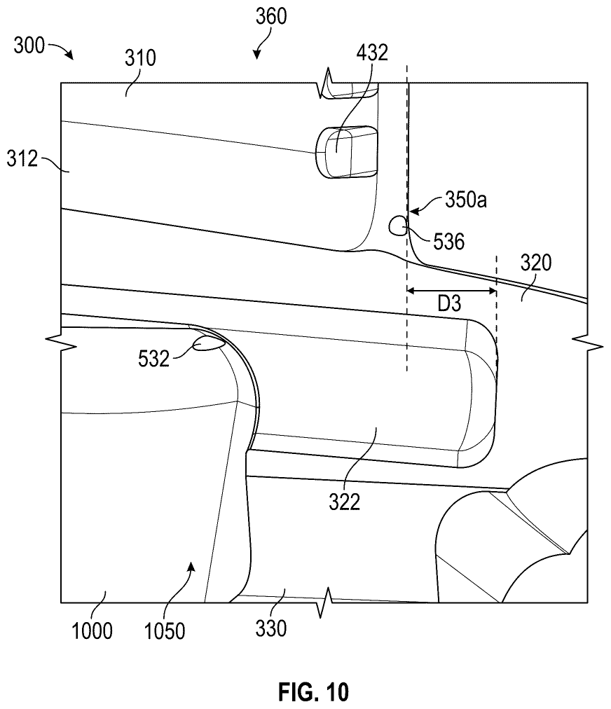

FIG. 10 is a perspective view of a portion of turbine blade 300, according to an embodiment. In particular, a cross-sectional view of platform 320 is shown to illustrate additional features of platform 320 that are not visible from its external surface. In this view, inlet 532 and outlet 536 of third aperture 530 are clearly visible. Inlet 532 may be in fluid communication with outlet 536 via a straight internal channel (not shown) through platform 320. Inlet 532 is through a surface of a recess 1000, extending from platform 320 to root 330, that defines a cavity 1050 under platform 320 between adjacent turbine blades 300. Thus, coolant (e.g., air) within this under-platform cavity 1050 may be forced or drawn into inlet 532, through the internal channel, and ejected out of outlet 536. Under-platform cavity 1050 may be pressurized to push coolant through third aperture 530. Outlet 536 is through trailing edge 350a of fillet 312, such that the coolant, ejected from outlet 536, cools trailing edge 350a of fillet 312. In an embodiment, outlet 536 is through a pressure side 360 of trailing edge 350a of fillet 312, to thereby cool pressure side 360 of trailing edge 350a of fillet 312.

As illustrated, platform 320 may comprise a pin seal slot 322 on pressure side 360 of platform 320. Although not shown, platform 320 may also comprise a corresponding pin seal slot 322 on suction side 370 of platform 320. A pin (not shown) may be inserted within corresponding pressure-side and suction-side pin seal slots 322 of adjacent turbine blades 300, to thereby seal under-platform cavity 1050, from the flow path of working fluid F above (i.e., radially outward from) platforms 320. In other words, the pin prevents working fluid F from entering under-platform cavity 1050, and prevents coolant in under-platform cavity 1050 from entering the flow path of working fluid F.

Pin seal slot 322 may be positioned laterally outward from recess 1000, such that the pin, when inserted within pin seal slot 322, does not obstruct the fluid communication between inlet 532 of third aperture 530 and under-platform cavity 1050. In other words, when a pin is seated with pin seal slot 322, the pin is prevented by pin seal slot 322 from protruding, at least beyond a certain point, into recess 1000. In particular, the axial ends of pin seal slot 322 and the corresponding pin may extend axially beyond recess 1000, such that the pin cannot be inserted laterally into recess 1000. This ensures that there is fluid communication between inlet 532 and under-platform cavity 1050, while still enabling the pin in adjacent pin seal slots 322 to provide a suitable seal between under-platform cavity 1050 and the flow path of working fluid F above platforms 320.

In addition, in an embodiment, the aft axial end of pin seal slot 322 may extend axially beyond trailing edge 350a of fillet 312, in the aft direction, by a distance D3 that is greater than zero. As an example, D3 may be greater than 5%, and preferably 10% or more, of the total distance between fillet 312 and the trailing edge of platform 320. While only one axial end of pin seal slot 322 on the aft side of platform 320 is illustrated, it should be understood that the forward axial end of pin seal slot 322 may be identical or similar, in that the forward axial end may also extend axially beyond leading edge 340a of fillet 312, in the forward direction, by a non-zero distance (e.g., less than D3, D3, or greater than D3). Alternatively, the forward axial end of pin seal slot 322 may be positioned below leading edge 340a of fillet 312 or axially aft of leading edge 340a of fillet 312.

In an embodiment, one or more, including potentially all of, first apertures 510, second apertures 520, third aperture(s) 530, fourth apertures 840, fifth apertures 838, apertures 412, and/or the like, may be formed using electrical discharge machining (EDM), drilling, or any other similar or suitable technique. Alternatively, turbine blade 300 may be manufactured with these apertures using a mold, additive manufacturing, or any other similar or suitable manufacturing method.

### INDUSTRIAL APPLICABILITY

In gas turbine engine 100, turbine blades 300 of turbine rotor assemblies 142, especially in the first stage of turbine 140, are subjected to extremely high gas temperatures and mechanical stresses. Accordingly, disclosed embodiments utilize one or more cooling and/or stress-reduction features.

As a first feature, one or more and preferably a plurality of flared and/or shaped first apertures 510 are provided through an exterior surface of platform 320, adjacent to leading edge 340a of fillet 312. The provision of coolant, through first aperture(s) 510, to this region of turbine blade 300 may reduce temperatures and/or mechanical stresses in this region of turbine blade 300, including fillet 312, which is a high-stress region, thereby improving the capability of the material in this region. In addition, the flaring and/or shaping of first apertures 510 may reduce the stress concentration at outlets 516 of first apertures 510.

As a second feature, one or more and preferably a plurality of flared and/or shaped second apertures 520 are provided through an exterior surface of leading edge 340a of fillet 312 of airfoil 310. The provision of coolant, through second aperture(s) 520, to this region of turbine blade 300 may reduce temperatures and/or mechanical stresses in this region of turbine blade 300, including fillet 312, which is a high-stress region, thereby improving the capability of material in this region. In addition, the flaring and/or shaping of second apertures 520 may reduce the stress concentration at the outlets of second apertures 520.

As a third feature, at least one third aperture 530 may be provided to supply coolant through an exterior surface of trailing edge 350a of fillet 312 of airfoil 310. Third aperture 530 may draw coolant from pressurized under-platform cavity 1050 to achieve a cooling target temperature at trailing edge 350a of fillet 312 that eliminates or reduces the likelihood of the initiation of fractures or cracking at trailing edge 350b of airfoil 310.

As a fourth feature, turbine blade 300 may comprise a tip flag 800 that supplies coolant to a tip of airfoil 310. Tip flag 800 may comprise a plurality of trip strips 850 that turbulate the flow of coolant through tip flag 800. For instance, trip strips 850 may promote turbulence within tip flag 800, which enhances heat transfer within tip flag 800. The provision of coolant, through fourth aperture(s) 840, to the tip of turbine blade 300 may reduce temperatures and/or mechanical stresses in the tip of turbine blade 300, thereby improving the capability of the material in this region.

As a fifth feature, turbine blade 300 may comprise a pin seal slot 322 whose axial ends extend beyond fillet 312 of airfoil 310. This axial extension of pin seal slot 322 beyond fillet 312 provides a pocket underneath trailing edge 350b of airfoil 310 that reduces stiffness and produces a transient behavior at this position, which may eliminate or reduce the likelihood of the initiation of cracks due to the temperature gradient between platform 320 and airfoil 310.

As a sixth feature, the radial height of spar 834 may be reduced, such that spar 834, which is cooled by parallel coolant flows in axial channel 830, is closer to the radially outermost surface of airfoil 310. This reduces the temperature gradient across spar 834 and allows spar 834 to remain at a higher temperature. In turn, this reduces stress at spar 834, thereby increasing the life of turbine blade 300.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in a gas turbine engine 100, it will be appreciated that it can be implemented in various other types of turbines and machines with rotor blades, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A turbine blade comprising:
a platform;
an airfoil extending radially outward from the platform, wherein the airfoil includes a fillet at an interface between the airfoil and the platform;
an internal cooling channel that extends radially through the platform and into the airfoil,
wherein the platform comprises a plurality of first apertures, wherein each of the plurality of first apertures respectively extends from the internal cooling channel to a first outlet that flares outward through an exterior surface of the platform at a position that is radially inward from a leading edge of the fillet, and wherein each first outlet is shaped to match an outer profile of the platform.

2. The turbine blade of claim 1, wherein the first outlets of at least a subset of the plurality of first apertures are through a pressure side of the platform.

3. The turbine blade of claim 2, wherein the plurality of first apertures comprises at least three first apertures.

4. The turbine blade of claim 1, wherein the fillet comprises a plurality of second apertures, wherein each of the plurality of second apertures respectively extends from the internal cooling channel to a second outlet that flares outward through the leading edge of the fillet, and wherein each second outlet is shaped to match an outer profile of the leading edge of the fillet.

5. The turbine blade of claim 1, further comprising at least one third aperture that extends from an inlet through a radially inward facing surface of the platform, through an interior of the platform, to a third outlet through a trailing edge of the fillet.

6. The turbine blade of claim 5, wherein the third outlet is through a pressure side of the fillet.

7. The turbine blade of claim 5, wherein the at least one third aperture consists of a single third aperture.

8. The turbine blade of claim 1, wherein the airfoil further includes a tip flag that comprises:
a radial channel that is oriented radially within an interior of the airfoil;
an axial channel that is oriented axially within the interior of the airfoil, wherein the axial channel includes one or more outlets through a trailing edge of the airfoil; and
a curved channel that fluidly connects a radially outward end of the radial channel to a forward end of the axial channel.

9. The turbine blade of claim 8, wherein the radial channel of the tip flag is oriented parallel to the internal cooling channel and is positioned aft of the internal cooling channel within the interior of the airfoil.

10. The turbine blade of claim 8, wherein the tip flag further comprises a plurality of fourth apertures, wherein each of the plurality of fourth apertures respectively extends from the axial channel to a fourth outlet through an exterior surface of the airfoil.

11. The turbine blade of claim 10, wherein the fourth outlets of at least a subset of the plurality of fourth apertures are through a pressure side of the exterior surface of the airfoil.

12. The turbine blade of claim 10, wherein the fourth outlets of at least a subset of the plurality of fourth apertures are through a radially outward end of a pressure side of the exterior surface of the airfoil.

13. The turbine blade of claim 8, wherein each of the radial channel and the axial channel comprises a plurality of trip strips.

14. The turbine blade of claim 8, wherein each of the radial channel and the axial channel comprises a plurality of trip strips on both a pressure side and a suction side of the respective channel.

15. The turbine blade of claim 1, wherein the platform comprises a pin seal slot on each of a pressure side and a suction side of the platform, and wherein an aft axial end of each pin seal slot extends axially beyond the trailing edge of the fillet, in an aft direction, by a non-zero distance.

16. A rotor assembly comprising a plurality of the turbine blade of claim 1, arranged annularly around a longitudinal axis.

17. A gas turbine engine comprising:
a compressor;
a combustor downstream from the compressor; and
a turbine downstream from the combustor, wherein the turbine comprises one or more of the rotor assembly of claim 16.

18. A turbine blade comprising:
a platform;
an airfoil extending radially outward from the platform, wherein the airfoil includes a fillet at an interface between the airfoil and the platform;
an internal cooling channel that extends radially through the platform and into the airfoil, wherein the platform comprises a plurality of first apertures, wherein each of the plurality of first apertures respectively extends from the internal cooling channel to a first outlet that flares outward through an exterior surface of the platform at a position that is radially inward from a leading edge of the fillet, and wherein each first outlet is shaped to match an outer profile of the exterior surface of the platform,
wherein the fillet comprises a plurality of second apertures, wherein each of the plurality of second apertures respectively extends from the internal cooling channel to a second outlet that flares outward through the leading edge of the fillet, and wherein each second outlet is shaped to match an outer profile of the leading edge of the fillet, and
wherein the turbine blade further comprises at least one third aperture that extends from an inlet through a radially inward facing surface of the platform, through an interior of the platform, to a third outlet through a trailing edge of the fillet.

19. The turbine blade of claim 18, wherein the airfoil further includes a tip flag that comprises:
a radial channel that is oriented radially within an interior of the airfoil, wherein the radial channel comprises a first plurality of trip strips;
an axial channel that is oriented axially within the interior of the airfoil, wherein the axial channel includes one or more outlets through a trailing edge on a pressure side of an exterior surface of the airfoil, and wherein the axial channel comprises a second plurality of trip strips;
a curved channel that fluidly connects a radially outward end of the radial channel to a forward end of the axial channel; and
a plurality of apertures, wherein each of the plurality of apertures respectively extends from the axial channel to an outlet through a radially outward end of the pressure side of the exterior surface of the airfoil.

20. A turbine blade comprising:
a platform; and
an airfoil extending radially outward from the platform, wherein the airfoil includes
a radial channel that is oriented radially within an interior of the airfoil,
an axial channel that is oriented axially within the interior of the airfoil, wherein the axial channel comprises one or more outlets through a trailing edge on a pressure side of an exterior surface of the airfoil,
a transitional channel that fluidly connects a radially outward end of the radial channel to a forward end of the axial channel, and
a plurality of apertures, wherein each of the plurality of apertures respectively extends from the axial channel to an outlet through a radially outward end of the pressure side of the exterior surface of the airfoil.
